(19) United States
(12) Patent Application Publication
(10) Pub. No.: US 2005/0160657 A1
(43) Pub. Date: Jul. 28, 2005

(54) Fishing hook enclosure apparatus

(76) Inventor: Geoffrey Dodge, South Salem, NY (US)

Correspondence Address: GEOFFREY DODGE, BOX 185, SOUTH SALEM, NY, 10590, US

(21) Appl. No.: 10/762,637

(22) Filed: Jan. 23, 2004

(51) Int. Cl. A01K 97/06

(52) U.S. Cl. 43/25.2

(57) ABSTRACT

The invention has a hook on one end of the enclosure to hook to an eyelet of a fishing pole and could have a bendable tongue to close the open hook end. The hook is part of the container which encloses the lure and has an opening for the fishing line on the opposite side of the container leading back to the real. The container is hinged to open and close or could be in two parts that snap together. The enclosing “box” could be cylindrical, square, or round. The idea is to enclose fishing lures or single hooks which come in many sizes and shapes while leaving them on the fishing pole.

### SUMMARY OF THE INVENTION

A fishing hook enclosure apparatus includes a first container portion which includes exterior attachment means and a first line access notch. A second container portion is attached to the first container portion by first-to-second attachment means. The exterior attachment means and the first line access notch are located at opposite ends of the first container portion. Preferably, the exterior attachment means are in the form of an exterior attachment hook. Once a fishing lure and fishing hooks are contained inside the closed container formed by the first container portion and the second container portion in a closed condition, the fishing lure and the fishing hooks are prevented from snagging or hooking into any person or object in the environment surrounding the closed container.

In accordance with one embodiment of the invention, the first-to-second attachment means include a hinge. The first container portion is in the form of a first half-cylinder portion; the second container portion is in the form of a second half-cylinder portion; and the hinge connects the first half-cylinder portion and the second half-cylinder portion together. Preferably, a lock is provided for locking the first half-cylinder portion to the second half-cylinder portion when the first half-cylinder portion and the second half-cylinder portion are in a closed condition.

The second half-cylinder portion can also include a second line access notch, and the first line access notch and the second line access notch are placed in registration with each other when the first half-cylinder portion and the second half-cylinder portion are in a closed condition. The first line access notch and the second line access notch form a combined line access notch when the first line access notch and the second line access notch are placed in registration.

In accordance with another embodiment of the invention, the first container portion is in the form of a box-like non-hinged container portion; the second container portion is in the form of a box-like non-hinged lid; and the first-to-second attachment means include a lid engagement flange on the non-hinged container portion which receives the non-hinged lid.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a side view showing a first embodiment of the fishing hook enclosure apparatus of the invention, in use, enclosing a fishing lure and hook and secured to a ring on a fishing rod.

FIG. 2 is an enlarged side view of the embodiment of the fishing hook enclosure apparatus shown in FIG. 1, contained in circled region 2, and removed from the ring and the fishing rod.

FIG. 3 is a top view of the embodiment of the fishing hook enclosure apparatus of FIG. 2 taken along line 3-3 thereof.

FIG. 4 is a cross-sectional view of the embodiment of the invention shown in FIG. 3 taken along line 4-4 thereof.

FIG. 5 is perspective view of the embodiment of the invention shown in FIGS. 1-4 in an open condition.

FIG. 6 is an exploded perspective view of a second embodiment of the invention in which a non-hinged lid fits on a non-hinged container portion.

### DESCRIPTION OF THE PREFERRED EMBODIMENT

With reference to the drawings, a new and improved fishing hook enclosure apparatus embodying the principles and concepts of the present invention will be described.

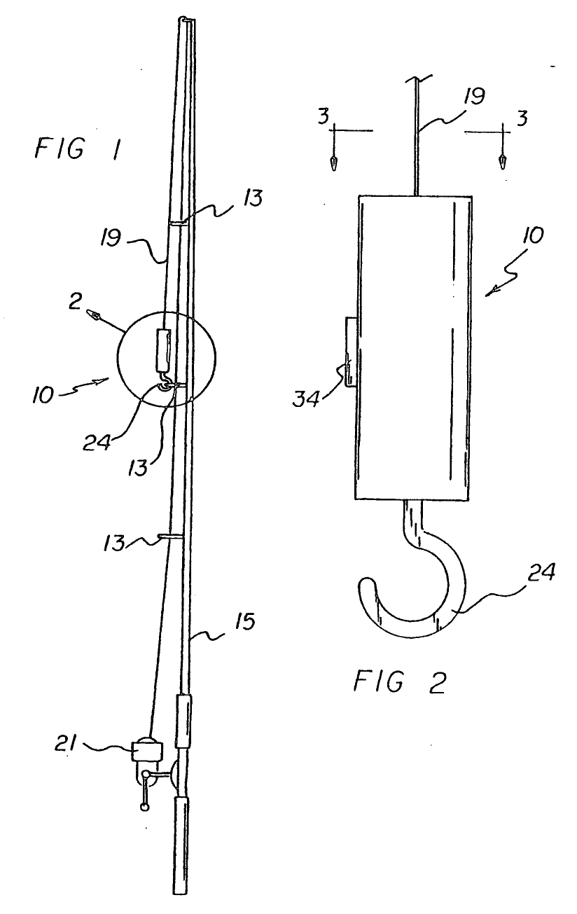

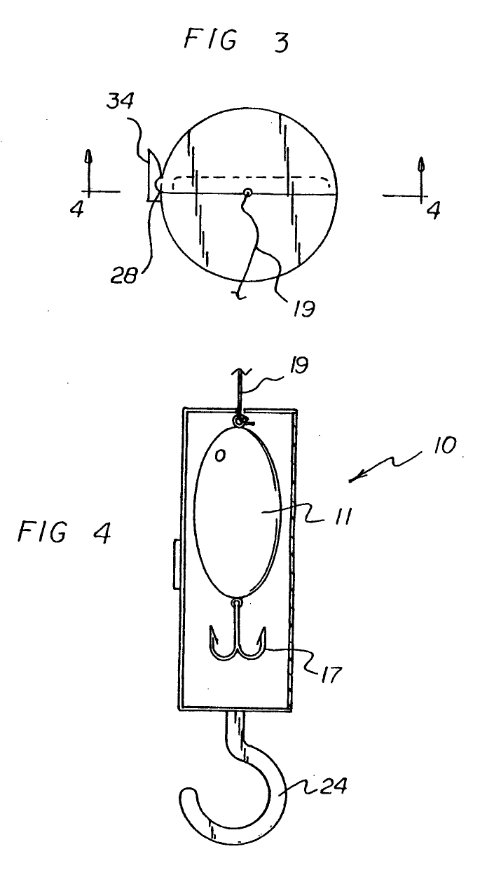

Turning to FIGS. 1-5, there is shown a first embodiment of the fishing hook enclosure apparatus of the invention generally designated by reference numeral 10. In the first embodiment, fishing hook enclosure apparatus 10 includes a first container portion which includes exterior attachment means and a first line access notch 14. A second container portion is attached to the first container portion by first-to-second attachment means. The exterior attachment means and the first line access notch 14 are located at opposite ends of the first container portion. Preferably, the exterior attachment means are in the form of an exterior attachment hook 24.

In accordance with one embodiment of the invention, the first-to-second attachment means includes a hinge 28. The first container portion is in the form of a first half-cylinder portion 12; the second container portion is in the form of a second half-cylinder portion 26; and the hinge 28 connects the first half-cylinder portion 12 and the second half-cylinder portion 26 together. Preferably, a lock 34 is provided for locking the first half-cylinder portion 12 to the second half-cylinder portion 26 when the first half-cylinder portion 12 and the second half-cylinder portion 26 are in a closed condition.

The second half-cylinder portion 26 can also include a second line access notch 30, and the first line access notch 14 and the second line access notch 30 are placed in registration with each other when the first half-cylinder portion 12 and the second half-cylinder portion 26 are in a closed condition. The first line access notch 14 and the second line access notch 30 form a combined line access notch when the first line access notch 14 and the second line access notch 30 are placed in registration.

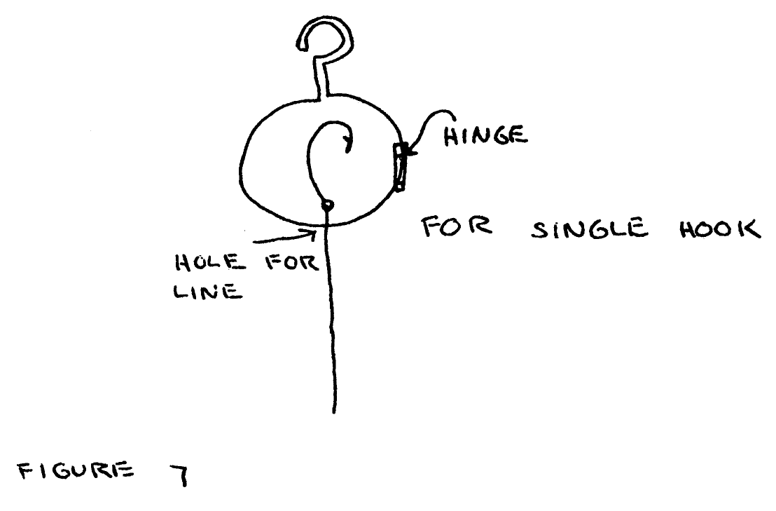

Turning to FIG. 6, a second embodiment of the invention is shown. Reference numerals are shown that correspond to like reference numerals that designate like elements shown in the other figures. In addition, the first container portion is in the form of a box-like non-hinged container portion 22; the second container portion is in the form of a box-like non-hinged lid 20; and the first-to-second attachment means include a lid engagement flange 32 on the non-hinged container portion 22 which receives the non-hinged lid 20.

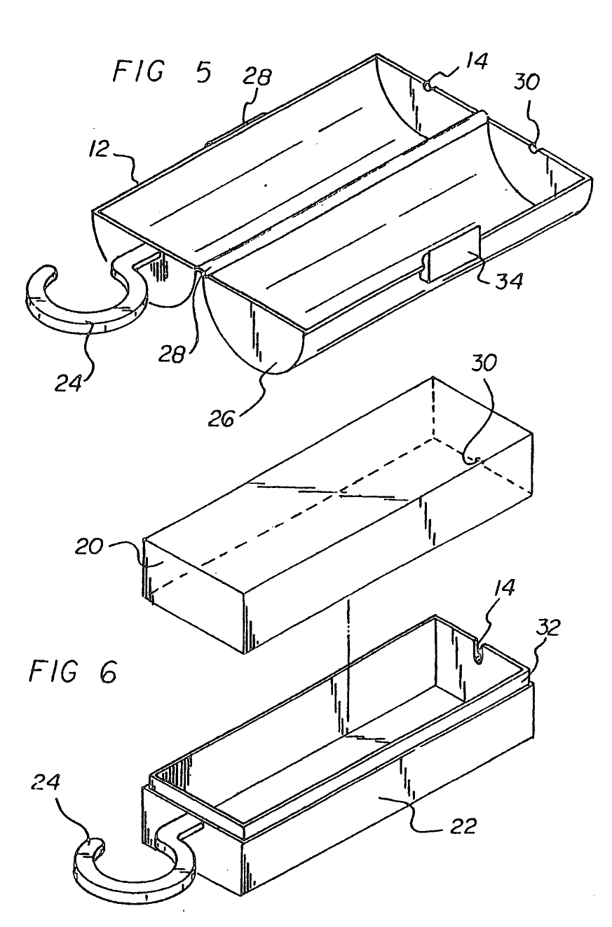

To use the first embodiment of the invention, the lock 34 is unlocked, and the second half-cylinder portion 26 is rotated around the first half-cylinder portion 12 along the hinge 28 to provide the open condition shown in FIG. 5. A fishing lure 11 which includes fishing hooks 17 is laid inside the first half-cylinder portion 12, and the second half-cylinder portion 26 is rotated around the hinge 28 to form the closed condition as shown in FIGS. 1-4. Before the closed condition is provided, the fishing line 19 is positioned in the first line access notch 14. When the second half-cylinder portion 26 is closed with respect to the first half-cylinder portion 12 in the closed condition, the fishing line 19 is positioned in the combined line access notch formed by the first line access notch 14 and the second line access notch 30 which are in registration with each other. Once the fishing lure I 1 and the fishing hooks 17 are contained inside the closed container formed by the first half-cylinder portion 12 and the second half-cylinder portion 26, the fishing lure 11 and the fishing hooks 17 are prevented from snagging or hooking into any person or object in the environment surrounding the closed container.

Once the fishing lure 11 and fishing hooks 17 are contained inside the closed container, the closed container can be stabilized with respect to the fishing rod 15 in the following manner. The exterior attachment hook 24 of the fishing hook enclosure apparatus 10 is hooked onto a selected ring 13 on the fishing rod 15. Once the exterior attachment hook 24 is hooked onto the selected ring 13, the reel 21 is operated to tighten the fishing line 19. When this is done, the tightened fishing line 19 secures the exterior attachment hook 24 onto the selected ring 13 so that the closed container is secured in a fixed position on the fishing rod 15.

To use the fishing lure 11 and the fishing hooks 17, the reel 21 is operated to reduce the tension on the fishing line 19 so that the exterior attachment hook 24 can be unhooked from the ring 13. Then, the closed container is opened and the fishing lure 11 and fishing hooks 17 are removed from the container. Then, the container is placed in some location for storage until needed again.

Use of the second embodiment of the invention is similar to the use of the first embodiment of the invention with the following differences. When the apparatus is in the open condition, the non-hinged lid 20 is removed from the non-hinged container portion 22. When the apparatus is in the closed container, the non-hinged lid 20 is placed on the non-hinged container portion 22 with the non-hinged lid 20 engaging the lid engagement flange 32 on the non-hinged container portion 22.

The components of the fishing hook enclosure apparatus of the invention can be made from inexpensive and durable metal and plastic materials.

The foregoing detailed description is considered as illustrative only of the principles of the invention. Numerous modifications and changes will readily occur to those skilled in the art and therefore, it is not desired to limit the invention to the exact construction and operation shown and described. Accordingly, all suitable modifications and equivalents falling within the broad scope of the subject matter described above may be resorted to in carrying out the present invention.

1 A fishing hook enclosure apparatus with one hinged side joining two sides that when closed clip together having a hook on the smaller of one of the two sides at either end of the apparatus and a hole or slot at the opposite end from the hook end:

2 A fishing hook enclosure apparatus that encloses a hook or hooks or a lure that they fit inside of.

3 A fishing hook enclosure apparatus that is rectangular, square, cylindrical or round that encloses a fishing a hook, hooks or lure.

4 A fishing hook enclosure apparatus that can be made by plastic die casting preferably of recyclable plastic.

5 A fishing hook enclosure apparatus that can be packaging for retail display and sales serving a dual service as a container and safety devise.

6 A fishing hook enclosure apparatus that can safely contain a fishing hook, hooks or lure without removing them from the fishing pole while being stored.

7 A fishing hook enclosure apparatus that is different colors.

8 A fishing hook enclosure apparatus that bares the name of the manufacturer of the lure or logo.

9 A fishing hook enclosure apparatus that could bare the name of a sponsor of fishing events or for advertising at said events.

10 A fishing hook enclosure apparatus that is clear or opaque.

11 A fishing hook enclosure apparatus that is cylindrical with the smaller ends where the hook to the eyelet and hole end are rounded.

12 A fishing hook enclosure apparatus that has a bendable tongue providing closer to the open hook end of the box which attaches to the eyelet.

13 A fishing hook enclosure apparatus comprised of two sides that slide together without a hinge with a slot for the fishing line on one end and a hook on the other that attaches to the eyelet of the pole that snaps closed.

14 A fishing hook enclosure apparatus that is different shapes to accommodate the hooks or lures that it is enclosing. It could be a fish shape.

15 A fishing hook enclosure apparatus that encloses a fishing hook, hooks or lures that prevents said hooks from attaching where they are not wanted to.

16 A fishing hook enclosure apparatus that is a new type of packaging for fishing hooks hook or lures that as a result serves a dual purpose in marketing and safety.

17 A fishing hook enclosure apparatus that is manufactured inexpensively that can be given away at fishing events bearing a sponsors name or logo as a premium.

18 A fishing hook enclosure apparatus that can safely enclose one hook in a round or oblong plastic enclosure with the accompanying hook to eyelet and line to real embodiments.

19 A fishing hook enclosure apparatus that can safely enclose a hook, hooks or lure in what looks like a Budweiser or Coors can a box of Preparation H or even a box of Crest for advertising purposes.
